(19) United States
(12) Patent Application Publication
(10) Pub. No.: US 2007/0279790 A1
(43) Pub. Date: Dec. 6, 2007

(54) ADJUSTABLE OUTPUT VOLTAGE REGULATOR FOR DISK DRIVE

(76) Inventor: Brian K. Tanner, San Jose, CA (US)

Correspondence Address: SCHWEGMAN, LUNDBERG & WOESSNER, P.A., P.O. BOX 2938, MINNEAPOLIS, MN, 55402, US

(21) Appl. No.: 11/421,395

(22) Filed: May 31, 2006

(51) Int. Cl. G11B 19/02; G11B 5/02

(52) U.S. Cl. 360/69; 360/55

(57) ABSTRACT

A method and circuit for powering a disk drive device involves determining an operating condition of the disk drive device. A power mode is selected consistent with the determined operating condition of the disk drive. Different components of the disk drive device are selectively powered consistent with the selected power mode. In one embodiment, a voltage regulator is provided different adjusting voltages to provide different desired target voltages for powering the different components.

### BACKGROUND

A disk drive is an information storage device. A disk drive includes one or more disks clamped to a rotating spindle, and at least one head for reading information representing data from and/or writing data to the surfaces of each disk. The head is supported by a suspension coupled to an actuator that may be driven by a voice coil motor. Control electronics in the disk drive provide electrical pulses to the voice coil motor to move the head to desired positions on the disks to read and write the data, and to park the head in a safe area when not in use or when otherwise desired for protection of the disk drive.

Disk drive devices are finding their way into a large variety of battery powered and portable devices, where minimizing power consumption is desired. Many disk drives have various modes of power conservation, including removing power from a spindle motor when the drive has not been used for a predetermined time. However, electronics in disk drive devices may also consume significant power. There is a need for reducing power consumption by disk drive electronics.

### BRIEF DESCRIPTION OF THE DRAWINGS

The invention is pointed out with particularity in the appended claims. However, a more complete understanding of the present invention may be derived by referring to the detailed description when considered in connection with the figures, wherein like reference numbers refer to similar items throughout the figures and:

FIG. 1 is an exploded view of a disk drive that uses example embodiments described herein.

FIG. 2 is a schematic diagram of a disk drive and includes various electrical portions of the disk drive, according to an example embodiment.

FIG. 3 is a block schematic diagram of a switching voltage regulator for a disk drive device according to an example embodiment.

FIG. 4 is a matrix of disk drive operating conditions used to determine voltage levels according to an example embodiment.

FIG. 5 is a flow chart illustrating selection of voltage levels based on a disk drive operating condition according to an example embodiment.

FIG. 6 is a representation of a computing system, according to an example embodiment.

The description set out herein illustrates the various embodiments of the invention and such description is not intended to be construed as limiting in any manner.

### DETAILED DESCRIPTION

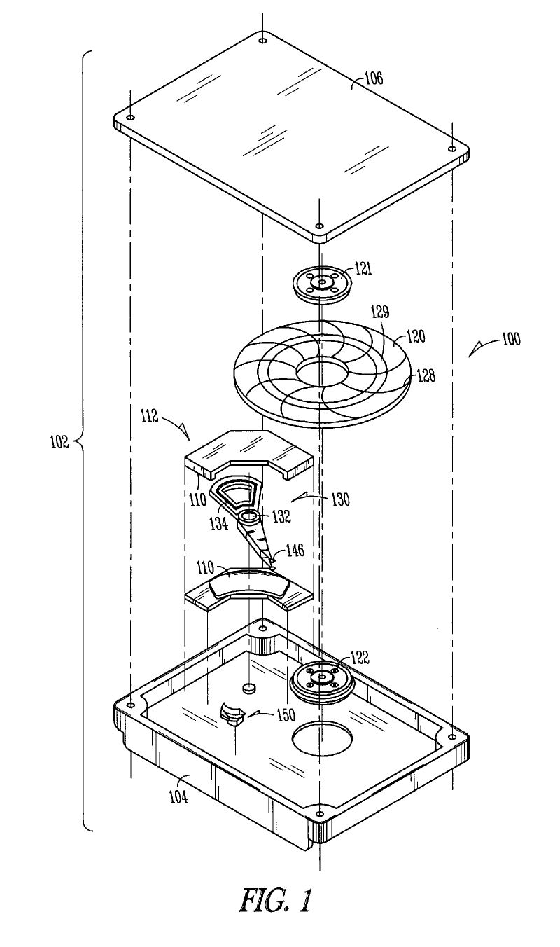

FIG. 1 is an exploded view of disk drive 100 that uses various embodiments of the present invention. The disk drive 100 includes a housing 102 including a housing base 104 and a housing cover 106. The housing base 104 illustrated is a base casting, but in other embodiments a housing base 104 can comprise separate components assembled prior to, or during assembly of the disk drive 100. A disk 120 is attached to a hub or spindle 122 that is rotated by a spindle motor. The disk 120 can be attached to the hub or spindle 122 by a clamp 121. The disk may be rotated at a constant or varying rate ranging from less than 3,600 to more than 15,000 revolutions per minute. Higher rotational speeds are contemplated in the future. The spindle motor is connected with the housing base 104. The disk 120 can be made of a light aluminum alloy, ceramic/glass or other suitable substrate, with magnetizable material deposited on one or both sides of the disk. The magnetic layer includes small domains of magnetization for storing data transferred through a transducing head 146. The transducing head 146 includes a magnetic transducer adapted to read data from and write data to the disk 120. In other embodiments, the transducing head 146 includes a separate read element and write element. For example, the separate read element can be a magneto-resistive head, also known as a MR head. It will be understood that multiple head 146 configurations can be used.

A rotary actuator 130 is pivotally mounted to the housing base 104 by a bearing 132 and sweeps an arc between an inner diameter (ID) of the disk 120 and a ramp 150 positioned near an outer diameter (OD) of the disk 120. Attached to the housing 104 are upper and lower magnet return plates 110 and at least one magnet that together form the stationary portion of a voice coil motor (VCM) 112. A voice coil 134 is mounted to the rotary actuator 130 and positioned in an air gap of the VCM 112. The rotary actuator 130 pivots about the bearing 132 when current is passed through the voice coil 134 and pivots in an opposite direction when the current is reversed, allowing for control of the position of the actuator 130 and the attached transducing head 146 with respect to the disk 120. The VCM 112 is coupled with a servo system (shown in FIG. 4) that uses positioning data read by the transducing head 146 from the disk 120 to determine the position of the head 146 over one of a plurality of tracks on the disk 120. The servo system determines an appropriate current to drive through the voice coil 134, and drives the current through the voice coil 134 using a current driver and associated circuitry (not shown in FIG. 1).

Each side of a disk 120 can have an associated head 146, and the heads 146 are collectively coupled to the rotary actuator 130 such that the heads 146 pivot in unison. The invention described herein is equally applicable to devices wherein the individual heads separately move some small distance relative to the actuator. This technology is referred to as dual-stage actuation (DSA).

One type of servo system is an embedded, servo system in which tracks on each disk surface used to store information representing data contain small segments of servo information. The servo information, in some embodiments, is stored in radial servo sectors or servo wedges 128 shown as several narrow, somewhat curved spokes substantially equally spaced around the circumference of the disk 120. It should be noted that in actuality there may be many more servo wedges than as shown in FIG. 1.

The disk 120 also includes a plurality of tracks on each disk surface. The plurality of tracks is depicted by two tracks, such as track 129 on the surface of the disk 120. The servo wedges 128 traverse the plurality of tracks, such as track 129, on the disk 120. The plurality of tracks, in some embodiments, may be arranged as a set of substantially concentric circles. Data is stored in fixed sectors along a track between the embedded servo wedges 128. The tracks on the disk 120 each include a plurality of data sectors. More specifically, a data sector is a portion of a track having a fixed block length and a fixed data storage capacity (e.g. 512 bytes of user data per data sector). The tracks toward the inside of the disk 120 are not as long as the tracks toward the periphery of the disk 120. As a result, the tracks toward the inside of the disk 120 can not hold as many data sectors as the tracks toward the periphery of the disk 120. Tracks that are capable of holding the same number of data sectors are grouped into data zones. Since the density and data rates vary from data zone to data zone, the servo wedges 128 may interrupt and split up at least some of the data sectors. The servo wedges 128 are typically recorded with a servo writing apparatus at the factory (called a servo-writer), but may be written (or partially written) with the transducing head 146 of the disk drive 100 in a self-servowriting operation.

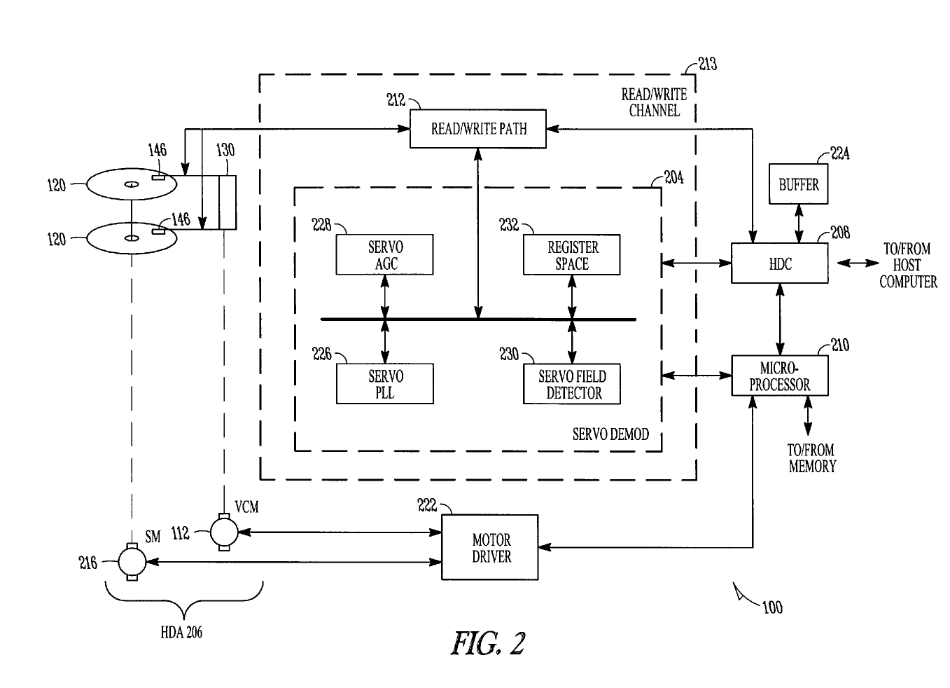

The disk drive 100 not only includes many mechanical features and a disk with a servo pattern thereon, but also includes various electronics for reading signals from the disk 120 and writing information representing data to the disk 120. FIG. 2 is a schematic diagram of a disk drive 200 that more fully details some of example electronic portions of the disk drive 100, according to an example embodiment. Referring to FIG. 2, the disk drive device 200 is shown as including a head disk assembly (HDA) 206, a hard disk controller (HDC) 208, a read/write channel 213, a microprocessor 210, a motor driver 222 and a buffer 224. The read/write channel 213 is shown as including a read/write path 212 and a servo demodulator 204. The read/write path 212, which can be used to read and write user data and servo data, may include front end circuitry useful for servo demodulation. The read/write path 212 may also be used for writing servo information in self-servowriting. It should be noted that the disk drive 100 also includes other components, which are not shown because they are not necessary to explain the example embodiments.

The HDA 206 includes one or more disks 120 upon which data and servo information can be written to, or read from, by transducers or transducing heads 146. The voice coil motor (VCM) 112 moves an actuator 130 to position the transducing heads 146 on the disks 120. The motor driver 222 drives the VCM 112 and the spindle motor (SM) 216. More specifically, the microprocessor 210, using the motor driver 222, controls the VCM 112 and the actuator 130 to accurately position the heads 146 over the tracks so that reliable reading and writing of data can be achieved. The servo wedges 128, discussed above, are used for servo control to keep the heads 146 on track and to assist with identifying proper locations on the disks 120 where data is written to or read from. When reading a servo wedge 128, the transducing heads 146 act as sensors that detect the position information in the servo wedges 128, to provide feedback for proper positioning of the transducing heads 146.

The servo demodulator 204 is shown as including a servo phase locked loop (PLL) 226, a servo automatic gain control (AGC) 228, a servo field detector 230 and register space 232. The servo PLL 226, in general, is a control loop that is used to provide frequency and phase control for the one or more timing or clock circuits, within the servo demodulator 204. For example, the servo PLL 226 can provide timing signals to the read/write path 212. The servo AGC 228, which includes (or drives) a variable gain amplifier, is used to keep the output of the read/write path 212 at a substantially constant level when servo wedges 128 on one of the disks 120 are being read. The servo field detector 230 is used to detect and/or demodulate the various subfields of the servo wedges 128, including a SAM, a track number, a first phase servo burst, and a second phase servo burst. The microprocessor 210 is used to perform various servo demodulation functions (e.g., decisions, comparisons, characterization and the like), and can be thought of as being part of the servo demodulator 204. In the alternative, the servo demodulator 204 can have its own microprocessor.

One or more registers (e.g., in register space 232) can be used to store appropriate servo AGC values (e.g., gain values, filter coefficients, filter accumulation paths, etc.) for when the read/write path 212 is reading servo data, and one or more registers can be used to store appropriate values (e.g., gain values, filter coefficients, filter accumulation paths, etc.) for when the read/write path 212 is reading user data. A control signal can be used to select the appropriate registers according to the current mode of the read/write path 212. The servo AGC value(s) that are stored can be dynamically updated. For example, the stored servo AGC value(s) for use when the read/write path 212 is reading servo data can be updated each time an additional servo wedge 128 is read. In this manner, the servo AGC value(s) determined for a most recently read servo wedge 128 can be the starting servo AGC value(s) when the next servo wedge 128 is read.

The read/write path 212 includes the electronic circuits used in the process of writing and reading information to and from disks 120. The microprocessor 210 can perform servo control algorithms, and thus, may be referred to as a servo controller. Alternatively, a separate microprocessor or digital signal processor (not shown) can perform servo control functions.

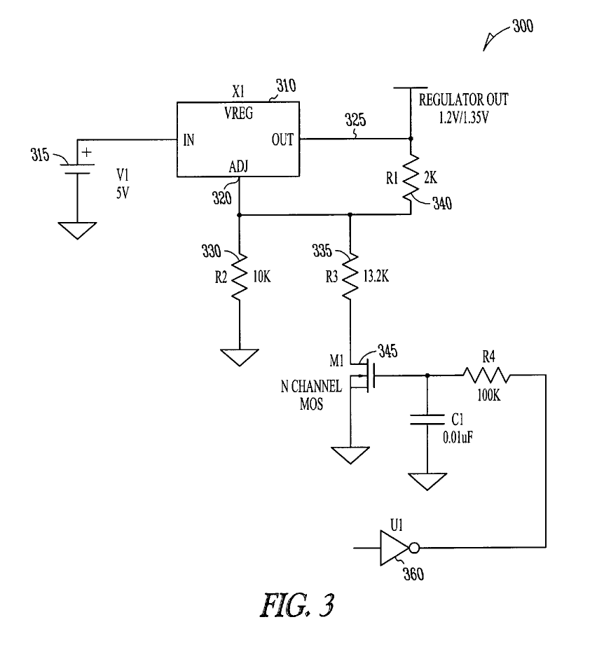

In one embodiment, power for the above disk drive components or modules is provided by a switching regulator circuit as shown at 300 in FIG. 3. A target voltage is provided as a function of a feedback voltage, which may be switched between two or more values to provide different target voltages.

A voltage regulator 310 is coupled to a supply voltage 315. Regulator 310 has an input 320 for adjusting an output voltage provided at 325. Input 320 is coupled to a filtered control signal switched between two fixed values formed by the combination of resistor 330, resistor 335 and resistor 340. Resistor 340 is coupled to the output voltage and to the input 320. Resistors 330 and 335 are controllably coupled to the input in parallel, effectively forming a variable voltage divider between resistor 340 and the selective parallel combination of resistors 330 and 335.

An N channel MOS transistor 345 is used as a switch to toggle between the two fixed voltage states comprising the control signal at input 320. Transistor 345 in an on state, allows current to flow through resistor 335, creating a parallel path for current through both resistors 330 and 335, resulting in a higher control voltage being provided to input 320. When transistor 345 is off, substantially all the current flows through resistor 330, resulting in a lower control voltage provided to input 320 corresponding to a higher regulator output 325. In one embodiment, the regulator voltage may be toggled between approximately 1.2 volts and 1.35 volts. In further embodiments, additional resistors (or resistors having different resistances) and switches may be provided to allow for additional regulator voltage output levels.

In one embodiment, an additional filter formed is formed by capacitor 350 and resistor 355 coupled to an input of transistor 345. This RC filter may be used to slowly transition between the two target voltage levels, as controlled by an input signal via an input 360, which in one embodiment is a device, such as an inverter that provides an appropriate level signal to either turn transistor 345 on or off.

In one embodiment, the time constant of the RC filter formed by the capacitor 350 and the resistor 355 is large enough to prevent significant transient events from occurring internal to the voltage regulator 310. The slowly ramped target voltage may substantially reduce the transient currents by limiting the magnitude of any voltage error detected by the voltage regulator 310. This allows switching between two voltage amplitudes based on the desired range of functionality required by the drive. When the drive is not actively transferring data, it allows a reduction in power dissipation effected by the reduced power supply voltage. This reduction in voltage is controlled when the drive changes operational state where various elements of the drive are made inactive or active. Power reductions on the order of 10% to 15% are possible depending on the ratio of leakage to active current flow in the system circuitry, such as an ASIC. The state function will be identified so as to program the proper regulator target voltage.

A matrix of different example disk drive conditions, illustrated in FIG. 4 at 400, may be used to determine an amount of power that should be provided to selected logic, such as a formatter and channel. When the disk drive is reading data 410, the logic and channel should be fully powered. The matrix will contain an indication 415 to the effect that a higher level voltage should be provided by the voltage regulator 310. During other times, like during a general power savings mode 420, or during a seek 425, the channel does not have to be used as heavily, so the matrix 400 may identify these conditions, and indicate that the lower voltage should be provided at 430 and 435 respectively. This results in lower power being provided to the logic and channel, saving power. Other methods of identifying a desired voltage level or power may be used, such as conditional statements in programming or hardware and/or firmware implementations.

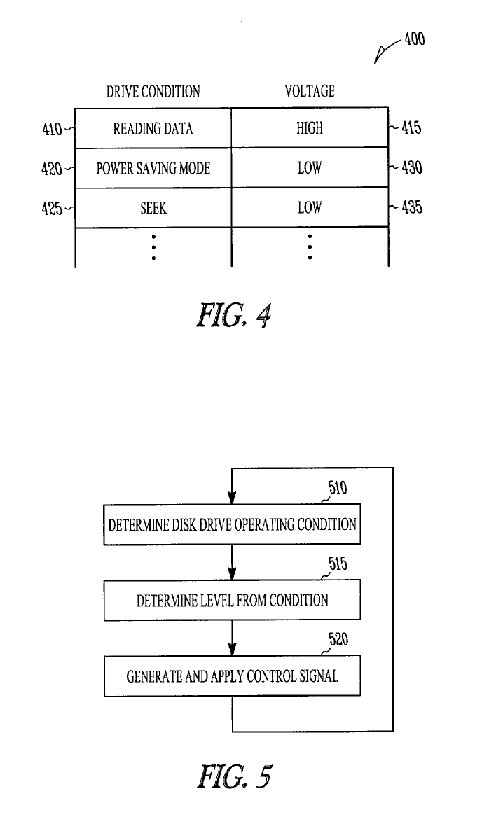

FIG. 5 illustrates a flow chart for determining which control voltage to provide to input 320. At 510, the disk drive condition is sensed or read from matrix 400. A corresponding level is read at 515. A control signal is generated at 520 and applied at the input 360 to cause the voltage regulator 310 to provide the appropriate voltage level to the selected portions of the disk drive. The process is repeated as the drive continues to change operational states. In further embodiments, the voltage regulator 310 may provide more than two levels of voltage, and the matrix may thus be modified to indicate as many levels as necessary. In still further embodiments, multiple voltage regulators may be provided, each coupled to different components or circuitry of the disk drive and separately controlled according to a matrix or other logic which is suitable for identifying levels based on operational states of the disk drive.

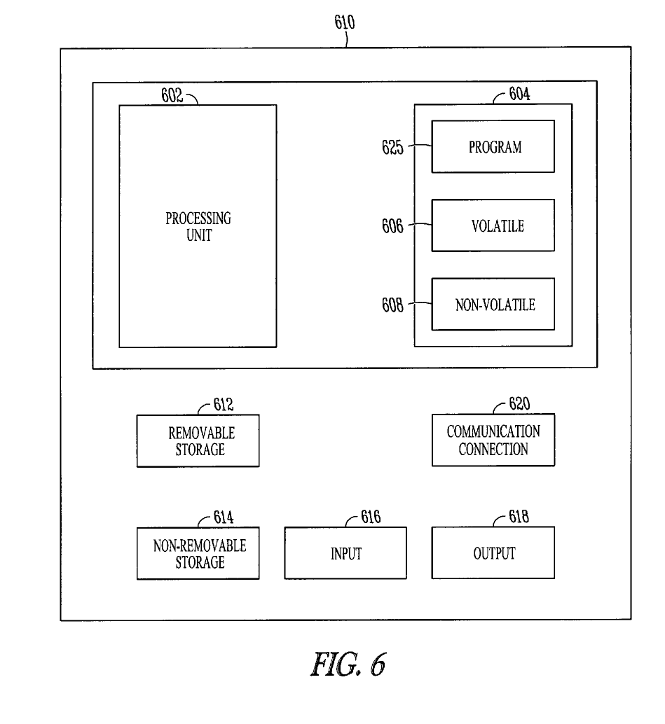

A block diagram of a computer system that executes programming for performing the above algorithm is shown in FIG. 6. A general computing device in the form of a computer 610, may include a processing unit 602, memory 604, removable storage 612, and non-removable storage 614. Memory 604 may include volatile memory 606 and non volatile memory 608. Computer 610 may include—or have access to a computing environment that includes—a variety of computer-readable media, such as volatile memory 606 and non volatile memory 608, removable storage 612 and non-removable storage 614. Computer storage includes random access memory (RAM), read only memory (ROM), erasable programmable read-only memory (EPROM) & electrically erasable programmable read-only memory (EEPROM), flash memory or other memory technologies, compact disk read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 610 may include or have access to a computing environment that includes input 616, output 618, and a communication connection 620. The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks. The microprocessor 210 or other selected circuitry or components of the disk drive may be such a computer system.

Computer-readable instructions stored on a computer-readable medium are executable by the processing unit 602 of the computer 610. A hard drive, CD-ROM, and RAM are some examples of articles including a computer-readable medium. For example, a computer program 625 executed to control the writing of information associated with successive flush cache commands from a host 640 according to the teachings of the present invention may be included on a CD-ROM and loaded from the CD-ROM to a hard drive. The computer program may also be termed firmware associated with the disk drive 100. In some embodiments, a copy of the computer program 625 can also be stored on the disk 120 of the disk drive 100.

The foregoing description of the specific embodiments reveals the general nature of the invention sufficiently that others can, by applying current knowledge, readily modify and/or adapt it for various applications without departing from the generic concept, and therefore such adaptations and modifications are intended to be comprehended within the meaning and range of equivalents of the disclosed embodiments.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

It is to be understood that the phraseology or terminology employed herein is for the purpose of description and not of limitation. Accordingly, the invention is intended to embrace all such alternatives, modifications, equivalents and variations as fall within the spirit and broad scope of the appended claims.

What is claimed is:

1. A method of powering a disk drive device, the method comprising:
determining an operating condition of the disk drive device;
selecting a power mode consistent with the determined operating condition of the disk drive; and
selectively powering components of the disk drive device consistent with the selected power mode.

2. The method of claim 1 wherein the different components of the disk drive device comprise selected logic and a channel.

3. The method of claim 1 wherein determining an operating condition of the disk drive device comprises utilizing a matrix of different conditions.

4. The method of claim 3 wherein the different conditions comprise at least one of reading data, seek, and general power savings mode.

5. The method of claim 1 and further comprising altering a voltage target of a pulse width modulator as a function of the selected power modes.

6. The method of claim 5 wherein each mode has a selected voltage target.

7. The method of claim 6 wherein there are multiple different voltage targets.

8. A method of providing power to a disk drive device, the method comprising:
determining an operating state of the disk drive device;
selecting a desired target voltage for a regulator as a function of the operating state of the disk drive device; and
providing one of multiple feedback voltages to the regulator to obtain the desired target voltage.

9. The method of claim 8 and further comprising using an RC filter to minimize transient current effects.

10. The method of claim 8 wherein determining an operational state of the disk drive device comprises utilizing a matrix of different operational states.

11. The method of claim 10 wherein the different operational states comprise reading data, seek, and general power savings mode.

12. The method of claim 8 wherein the target voltages comprise a high voltage and a low voltage.

13. The method of claim 12 wherein the low voltage is approximately 1.2V, and the high voltage is approximately 1.35V.

14. A circuit for providing multiple voltage levels to a disk drive device, the circuit comprising:
a voltage regulator having a target voltage output as a function of a control voltage input;
a voltage divider having a first resistor coupled to the output and the input, and a pair of parallel resistors coupled to the input to provide the control voltage input; and
a switch coupled to one of the pair of parallel resistors for controllably switching current through the one of the pair of parallel resistors to modify control voltage input levels.

15. The circuit of claim 14 wherein the target voltages comprise a high voltage and a low voltage.

16. The circuit of claim 15 wherein the low voltage is approximately 1.2V, and the high voltage is approximately 1.35V.

17. The circuit of claim 14 wherein the switch has an input coupled to an RC filter.

18. The circuit of claim 14 wherein a matrix of disk drive operational states is used to switch between voltage levels.

19. A circuit for providing multiple voltage levels to a disk drive device, the circuit comprising:
means for determining an operating condition of the disk drive device;
means for selecting a power mode consistent with the determined operating condition of the disk drive; and
means for selectively powering components of the disk drive device consistent with the selected power mode.

20. A disk drive device comprising:
a monitor to monitor at least one operating condition of the disk drive device;
a voltage regulator to provide power to at least one component of the disk drive device, the voltage regulator having a target voltage output responsive to a control voltage input; and
a controller to vary the control voltage input based on the at least one monitored operating condition.

21. The disk drive device of claim 20, wherein the controller comprises an adjustable voltage divider that switches between at least two control voltage inputs based on the monitored operating condition.
